(19) United States
(12) Patent Application Publication
(10) Pub. No.: US 2025/0013949 A1
(43) Pub. Date: Jan. 9, 2025

(54) INFORMATION PROCESSING METHOD AND APPARATUS, TERMINAL, AND STORAGE MEDIUM

(71) Applicant: Beijing Zitiao Network Technology Co., Ltd., Beijing (CN)

(72) Inventor: Jixue LEI, Beijing (CN)

(21) Appl. No.: 18/709,310

(22) PCT Filed: Nov. 15, 2022
(86) PCT No.: PCT/CN2022/131910

§ 371 Date: May 10, 2024

(30) Foreign Application Priority Data
Nov. 15, 2021 (CN) 202111348450.6

(51) Int. Cl. G06Q 10/0631

(52) U.S. Cl. CPC G06Q 10/063112

(57) ABSTRACT

The present disclosure provides an information processing method and apparatus, a terminal, and a storage medium. The present disclosure adopts the following technical solution. The present disclosure provides an information processing method, including: determining a target person and first task information associated with the target person; on the basis of the first task information, determining recommended evaluators who are associated with the first task information; and displaying the recommended evaluators in a recommendation region of a display interface.

### CROSS-REFERENCE TO RELATED APPLICATION

The present application is proposed based on Chinese patent application No. 202111348450.6 filed on Nov. 15, 2021 and entitled “Information Processing Method, Apparatus, Terminal and Storage Medium”, and claims the priority to the Chinese patent application, the disclosure of which is incorporated herein by reference in its entirety.

### TECHNICAL FIELD

The present disclosure relates to the field of computer technology, and in particular to an information processing method, apparatus, terminal and storage medium.

### BACKGROUND

In an enterprise, it is sometimes necessary to evaluate personnel. When evaluating, it is necessary to invite evaluators. The selection of evaluators is very important for correctly evaluating of the to-be-evaluated person.

### SUMMARY

The present disclosure provides an information processing method, apparatus, terminal and storage medium.

The present disclosure adopts the following technical solutions.

In some embodiments, the disclosure provides an information processing method, characterized by including:
determining a target person and first task information associated with the target person;
determining, based on the first task information, a recommended evaluator having an association relationship with the first task information; and
displaying the recommended evaluator in a recommendation region of a display interface.

In some embodiments, the disclosure provides an information processing apparatus, characterized by including:
a first determining unit, configured to determine a target person and first task information associated with the target person;
a second determining unit, configured to determine, based on the first task information, a recommended evaluator having an association relationship with the first task information;
a display unit, configured to display the recommended evaluator in a recommendation region of a display interface.

In some embodiments, the disclosure provides a terminal, including at least one memory and at least one processor;
wherein the at least one memory is configured to store program codes, and the at least one processor is configured to call the program codes stored in the at least one memory to execute the above method.

In some embodiments, the disclosure provides a computer-readable storage medium. The computer-readable storage medium stores program codes thereon. The program codes, when executed by a processor, causes the processor to execute the above method.

According to the information processing method provided by the embodiment of the present disclosure, by using the first task information of the target person, the recommended evaluator having an association relationship with the first task information is determined, thereby realizing the intelligent recommendation of evaluators. Both the recommended evaluator and the target person are associated with the first task information, and this indicates a strong work correlation between the recommended evaluator and the target person, so that the determining method of the recommended evaluator is more objective and reliable.

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale.

FIG. 1 is a flowchart of an information processing method according to an embodiment of the present disclosure.

FIG. 2 is a schematic diagram of a configuration interface according to an embodiment of the present disclosure.

FIG. 3 is a schematic diagram of a display interface according to an embodiment of the present disclosure.

FIG. 4 is a schematic structural diagram of an electronic device according to an embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

Modifications of “one” mentioned in the present disclosure is schematic rather than restrictive, and it should understand that unless otherwise explicitly stated in the context, it should be understood as “one or more.”

The names of messages or information exchanged between multiple apparatuses in the embodiments of the present disclosure are used for illustrative purposes only, and are not used to limit the scope of these messages or information.

The solutions provided by the embodiments of the present disclosure will be described in detail below with reference to the accompanying drawings.

In the enterprise, it is sometimes necessary to evaluate personnel. At this time, it is necessary to determine an evaluator, and the evaluator will evaluate the to-be-evaluated person. If the evaluator is invited by the to-be-evaluated person, it may lead to strong subjectivity of the evaluator, and the evaluator may have little work correlation to with the to-be-evaluated person.

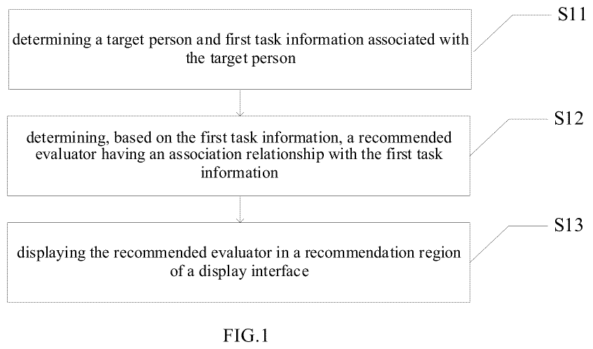

As illustrated in FIG. 1, which is a flowchart of an information processing method according to an embodiment of the present disclosure, the method includes the following steps.

S11: determining a target person and first task information associated with the target person.

In some embodiments, the target person is a to-be-evaluated person, the target person is associated with the first task information, and the first task information can be task information that the target person is responsible for or task information that the target person participates in. The number of the first task information can be multiple, that is, the target person can be associated with multiple first task information.

S12: determining, based on the first task information, a recommended evaluator having an association relationship with the first task information.

In some embodiments, the recommended evaluator is also associated with the first task information. In the case where the number of first task information is multiple, the recommended evaluator can be associated with one or more of the first task information. The recommended evaluator can be a person responsible for the first task information or a participant in a first task; or second task information of the recommended evaluator is associated with the first task information, and the second task information is task information that the recommended evaluator is responsible for or participates in.

S13: displaying the recommended evaluator in a recommendation region of a display interface.

In some embodiments, the display interface can be an evaluator selection interface of the target person, and the evaluator of the target person is determined in the display interface. There is a recommendation region in the display interface, and recommended evaluators are displayed in the recommendation region, and the recommended evaluators displayed in the recommendation region can be selected as evaluators of the target person, so that the target person can select the recommended evaluators as the evaluators of the target person in the display interface. In some embodiments, the number of recommended evaluators displayed does not exceed a preset number.

In some embodiments of the present disclosure, by using the first task information of the target person, the recommended evaluator having an association relationship with the first task information is determined, thereby realizing the intelligent recommendation of evaluators. Both the recommended evaluator and the target person are associated with the first task information, which indicates a strong work correlation between the recommended evaluator and the target person, so that the recommendation method of the recommended evaluator is more objective and reliable.

In some embodiments of the present disclosure, the determining first task information associated with the target person includes: determining a target evaluation period, and determining the first task information associated with the target person within the target evaluation period. In some embodiments, the evaluation on the target person is often the evaluation on his/her performance over a period of time, that is, the evaluation has a corresponding evaluation period. For example, the performance of the target person in May is evaluated, that is, May is a target evaluation period. Therefore, the first task information determined should be task information within a target evaluation period, thereby ensuring that the recommended evaluator determined based on the first task information has work correlation with the target person within the target evaluation period.

In some embodiments of the present disclosure, the determining, based on the first task information, a recommended evaluator having an association relationship with the first task information includes: determining a recommended evaluator who has an association relationship with the first task information and does not belong to a preset type of personnel. In some embodiments, the preset types of personnel is preset, and the preset type of personnel cannot be set as recommended evaluators, so that some personnel who are related to the target person at work but are not suitable as evaluators can be eliminated, and false recommendation can be avoided.

In some embodiments of the present disclosure, the preset types of personnel include at least one of the following: an evaluator in other evaluation sections for the target person, an evaluator invited by default, a person without a first authorization, and a person already resigned. In some embodiments, the target person has multiple associated evaluation sections. In the present embodiment, the recommended evaluator is a recommended evaluator of the target evaluation link. If a person is already an evaluator in a non-target evaluation link, he/she cannot be displayed as the recommended evaluator in the target evaluation link, that is, one person cannot be an evaluator of two evaluation sections. The evaluation link can be, for example, multiple task nodes that the target person participates in within a project, or different contents that the target person needs to be evaluated. In this way, the strong subjectivity of the evaluation on the target person caused by one person's evaluation on multiple sections for the target person is avoided, and the rationality and objectivity of the evaluation are improved. In some embodiments, the evaluator in other evaluation sections for the target person can be a direct superior and a dotted superior of the target person, that is, the recommended evaluator does not include the direct superior and the dotted superior of the target person. In some embodiments, the target person has an evaluator invited by default, and the evaluator invited by default can be a direct subordinate of the target person. At this time, because the evaluator has been invited by default, he/she is no longer regarded as a recommended evaluator. In some embodiments, it is necessary to have the first authorization to evaluate the target person, and a person who does not have the first authorization cannot be an evaluator of the target person. In some embodiments, a person already resigned cannot evaluate the target people currently employed.

In some embodiments of the present disclosure, the recommended evaluator is bound to the first task information in advance, and the recommended evaluator bound to the first task information remains unchanged after being bound. In some embodiments, the task information is bound with the recommended evaluator after being created, so the recommended evaluator bound to the first task information can be directly obtained; the recommended evaluator will not be changed after being bound, thus avoiding the problem that the evaluation is not objective due to the change of the recommended evaluator. If the recommended evaluator can be changed, the recommended evaluator may have just been associated with the task information, which will make it impossible for the recommended evaluator to objectively and comprehensively evaluate the target person. Therefore, in some embodiments, the recommended evaluator of the task information will not be changed after being bound.

In some embodiments of the present disclosure, the determining first task information associated with the target person includes: determining whether there is a selected data source; if there is, determining the first task information based on the selected data source; otherwise, sending a first prompt message. In some embodiments, the data source refers to the location of the data source in which the task information is located. After the function of intelligent recommendation of evaluators is enabled, it will be verified to determine whether the data source is selected. If selected, the first task information will be selected from the selected data source; otherwise, the first prompt message will be sent, which can prompt “Please select at least one recommended data source”. By selecting the data source, the target person can be evaluated according to different tasks, so that the evaluation is more focused on the performance of the target person in certain tasks.

In some embodiments, please refer to FIG. 2, which illustratively shows a schematic diagram of a configuration interface. As can be seen from the figure, whether or not to enable intelligent recommendation of evaluators can be set therein. If this option is enabled, the recommended evaluator can be displayed by executing the method according to the embodiment of the present disclosure; otherwise, the recommended evaluator may not be displayed, the role invited by default, that is, the person who serves as the evaluator by default, can be set. The number of evaluators to be invited can be set.

In some embodiments of the present disclosure, before the determining first task information associated with the target person, the method further includes: determining whether the target person has a second authorization on task information; if the target person has the second authorization, determining the first task information associated with the target person; or, if the target person does not have the second authorization, sending a second prompt message.

In some embodiments, the second authorization of the task information can be the authorization to use the task information. If a user does not have the authorization to use the task information, it is naturally impossible to display the recommended evaluator for the user through the task information. At this time, a prompt message can be displayed, for example, prompting “After being enabled, evaluators will be automatically recommended for the user”.

In some embodiments of the present disclosure, before the displaying the recommended evaluator in a recommendation region of a display interface, the method further includes: determining whether a preset condition is met, and if the preset condition is met, displaying the recommended evaluator in the recommendation region of the display interface; wherein the preset condition includes at least one of the following: the target person inviting an evaluator for himself/herself, an associated user of the target person having invited an evaluator for the target person, and an option of recommending evaluators being enabled.

In some embodiments, the scenes in which the recommended evaluator needs to be displayed are preset, such as when the to-be-evaluated person invites an evaluator for himself/herself, when an associated user invites an evaluator for the to-be-evaluated person, and so on. The associated user of the target person can be a superior of the target person or an instructor of the target person, etc. The option of recommending evaluators can be “intelligent recommendation of evaluators” in FIG. 2.

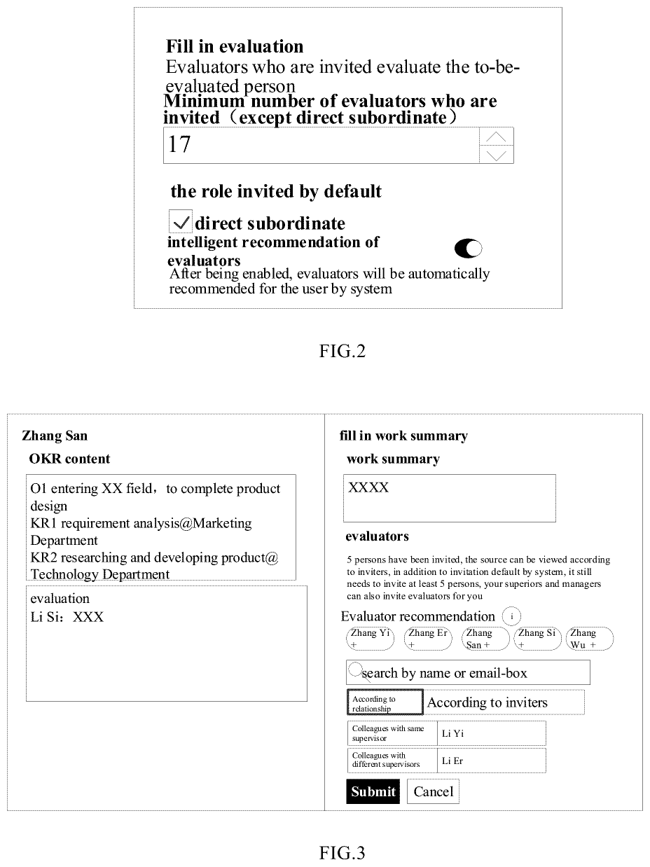

In some embodiments of the present disclosure, a first identifier is displayed in an associated region of the recommendation region, the first identifier is configured to be triggered to display a third prompt message, and the third prompt message is used to prompt a source of the recommended evaluator. In some embodiments, please refer to FIG. 3, which illustratively shows a schematic diagram of a display interface. On the right side of FIG. 3, “Evaluator Recommendation” is displayed, and below it, the recommended evaluator is displayed. The symbol on the right side of the title and having “i” therein is a first identifier, the first identifier is associated with the recommendation region and is configured to be triggered to display the source of the recommended evaluator. For example, in the present embodiment, the recommended evaluator is derived from the associated data of the task information within the target period, and the first identifier can be used to determine the recommendation criteria for the recommended evaluator being displayed.

In some embodiments of the present disclosure, the recommended evaluator displayed in the recommendation region has an associated second identifier, and the second identifier is configured to be triggered to add the associated recommended evaluator as an evaluator of the target person. In some embodiments, please continue to refer to FIG. 3, the second identifier can be an add button, that is, the “+” on the right side of the recommended evaluator, for example, the “+” on the right side of “Zhang Yi”. By triggering the second identifier, the corresponding recommended evaluator can be added as the evaluator of the target person.

In some embodiments, after the recommended evaluator is added as an evaluator, the recommended evaluator is hidden in the recommendation region, and no new recommended evaluator is added. In some embodiments, after the recommended evaluator are added as the evaluator of the target person, the recommended evaluator will not be displayed in the recommendation region to avoid repeated addition, and no new recommended evaluator will be added. If all recommended evaluators are added as evaluators, a fourth prompt message is displayed, for example, prompting “All recommended evaluators have been added”; because no recommended evaluator will be added, this ensures that the recommended evaluators displayed are the most relevant persons. If the recommended evaluators are constantly changed, less relevant persons may be added as recommended evaluators.

In some embodiments of the present disclosure, the method further includes: in response to a first person being removed from the evaluator of the target person, displaying, if the first person is the recommended evaluator, the first person in the recommendation region. In some embodiments, if the first person was originally a recommended evaluator and was deleted from the list of evaluators after being added as an evaluator, the first person should still be a recommended evaluator and displayed again in the recommendation region.

In some embodiments of the present disclosure, task information includes first-type information and second-type information which are associated; and the first-type information or the second-type information in the first task information has an association relationship with the first-type information or the second-type information in second task information of the recommended evaluator. In some embodiments, one piece of task information includes one piece of first-type information and at least one piece of second-type information, one piece of first-type information can be associated with a plurality of pieces of second-type information, and the first-type information and the second-type information are different types of information. For example, the task information can be target and key result information, the first type information can be target information, and the second type information can be key result information. The association relationship between the second task information and the first task information can be an alignment relationship, that is, an association relationship is established between one piece of target and key result information and another piece of target and key result information through mutual alignment.

In some embodiments of the present disclosure, the first task information has an association identifier, and the first task information is associated with the recommended evaluator through the association identifier. In some embodiments, the association identifier can be an “@” symbol, which can be used to remind someone. If a certain user is reminded in one piece of task information, an association relationship is established between the user and the task information through the association identifier.

In some embodiments of the present disclosure, recommended evaluators who can evaluate the target person are recommended for the target person through the association relationship of the target person in the task information, thus realizing the intelligent recommendation of the system. The personnel associated with the first task information within the target period serve as recommended evaluators, and the recommended evaluators can be directly added as evaluators without manual search, thus improving the convenience.

In some embodiments of the present disclosure, an information processing apparatus is further proposed, which includes:
a first determining unit, configured to determine a target person and first task information associated with the target person;
a second determining unit, configured to determine, based on the first task information, a recommended evaluator having an association relationship with the first task information;
a display unit, configured to display the recommended evaluator in a recommendation region of a display interface.

In some embodiments of the present disclosure, determining first task information associated with the target person includes: determining a target evaluation period, and determining the first task information associated with the target person within the target evaluation period.

In some embodiments of the present disclosure, determining, based on the first task information, a recommended evaluator having an association relationship with the first task information includes: determining a recommended evaluator who has an association relationship with the first task information and does not belong to a preset type of personnel.

In some embodiments of the present disclosure, the preset type of personnel includes at least one of the following: an evaluator in other evaluation sections for the target person, an evaluator invited by default, a person without a first authorization, and a person already resigned.

In some embodiments of the present disclosure, the recommended evaluator is bound to the first task information in advance, and the recommended evaluator bound to the first task information remains unchanged after being bound.

In some embodiments of the present disclosure, determining first task information associated with the target person includes:
determining whether there is a selected data source;
if there is, determining the first task information based on the selected data source;
otherwise, sending a first prompt message.

In some embodiments of the present disclosure, before determining first task information associated with the target person, the first determining unit is further configured to: determine whether the target person has a second authorization on task information; if the target person has the second authorization, determine the first task information associated with the target person; or, if the target person does not have the second authorization, send a second prompt message.

In some embodiments of the present disclosure, before displaying the recommended evaluator in a recommendation region of a display interface, the display unit is further configured to: determine whether a preset condition is met, and if the preset condition is met, display the recommended evaluator in the recommendation region of the display interface; wherein the preset condition includes at least one of the following: the target person inviting an evaluator for himself/herself, an associated user of the target person having invited an evaluator for the target person, and an option of recommending evaluators being enabled.

In some embodiments of the present disclosure, a first identifier is displayed in an associated region of the recommendation region, the first identifier is configured to be triggered to display a third prompt message, and the third prompt message is used to prompt a source of the recommended evaluator.

In some embodiments of the present disclosure, the recommended evaluator displayed in the recommendation region has an associated second identifier, and the second identifier is configured to be triggered to add the associated recommended evaluator as an evaluator of the target person.

In some embodiments of the present disclosure, the display unit is further configured to hide the recommended evaluator in the recommendation region after the recommended evaluator is added as an evaluator, and add no new recommended evaluator.

In some embodiments of the present disclosure, the display unit is further configured to: in response to a first person being removed from the evaluator of the target person, display, if the first person is the recommended evaluator, the first person in the recommendation region.

In some embodiments of the present disclosure, task information includes first-type information and second-type information which are associated; the first-type information or the second-type information in the first task information has an association relationship with the first-type information or the second-type information in second task information of the recommended evaluator; or, the first task information has an association identifier, and the first task information is associated with the recommended evaluator through the association identifier.

In terms of the embodiments of the apparatus, they substantially correspond to the method embodiments, so reference can be made to the partial description of the method embodiments for relevant parts. The above-described apparatus embodiments are merely illustrative, and the modules illustrated as separate modules may or may not be separate. Part or all of the modules may be selected according to actual needs to achieve the purpose of the solution of the present embodiment. One of ordinary skill in the art can understand and implement without creative efforts.

The method and apparatus of the present disclosure have been described above based on the embodiments and application examples. In addition, the present disclosure further provides a terminal and a storage medium, which are described below.

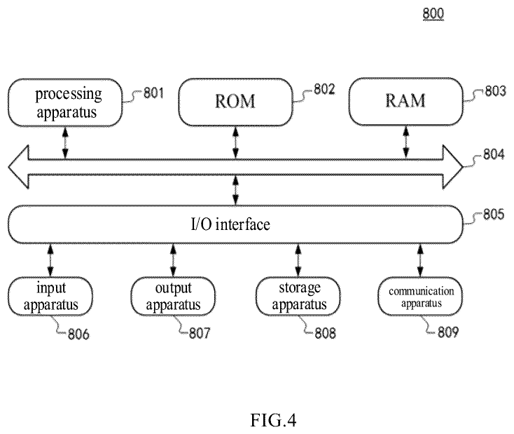

Hereinafter, please refer to FIG. 4, which shows a schematic structural diagram of an electronic device (e.g., terminal device or server) 800 suitable for implementing the embodiment of the present disclosure. The terminal device in the embodiment of the present disclosure can include, but is not limited to, a mobile terminal such as a mobile phone, a laptop computer, a digital broadcast receiver, a personal digital assistant (PDA), a portable android device (PAD), a portable media player (PMP), a vehicle-mounted terminal (e.g., vehicle-mounted navigation terminal), etc., and a fixed terminal such as a digital TV, a desktop computer, etc. The electronic device illustrated in the figure is merely an example, and should not limit the functions and application scope of the embodiments of the present disclosure.

The electronic device 800 can include a processing apparatus (e.g., central processing unit, graphics processing unit, etc.) 801, which can execute various appropriate actions and processes according to a program stored on a read-only memory (ROM) 802 or a program loaded from a storage apparatus 808 into a random access memory (RAM) 803. In the RAM 803, various programs and data necessary for the operations of the electronic device 800 are also stored. The processing apparatus 801, the ROM 802, and the RAM 803 are connected to each other through a bus 804. An input/output (I/O) interface 805 is also connected to the bus 804.

Generally, the following apparatuses can be connected to the I/O interface 805: an input apparatus 806 including, for example, a touch screen, a touch pad, a keyboard, a mouse, a camera, a microphone, an accelerometer, a gyroscope, etc.; an output apparatus 807 including, for example, a liquid crystal display (LCD), a speaker, a vibrator, etc.; a storage apparatus 808 including, for example, a magnetic tape, a hard disk, etc.; and a communication apparatus 809. The communication apparatus 809 can allow the electronic device 800 to perform wireless or wired communication with another device to exchange data. Although the electronic device 800 having various apparatuses is shown in the figure, it is to be understood that all illustrated apparatuses are not required to be implemented or provided. More or fewer apparatuses can be alternatively implemented or provided.

In particular, according to the embodiment of the present disclosure, the process described above with reference to the flowcharts can be implemented as a computer software program. For example, an embodiment of the present disclosure includes a computer program product, the computer program product includes a computer program carried on a computer-readable medium, and the computer program contains program codes for performing the method illustrated by the flowcharts. In such an embodiment, the computer program can be downloaded and installed from a network via the communication apparatus 809, or installed from the storage apparatus 808, or installed from the ROM 802. When the computer program is executed by the processing apparatus 801, the above functions defined in the method according to the embodiment of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to execute the above methods of the disclosure.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the disclosure, an information processing method is provided. The method includes:
determining a target person and first task information associated with the target person;
determining, based on the first task information, a recommended evaluator having an association relationship with the first task information; and
displaying the recommended evaluator in a recommendation region of a display interface.

According to one or more embodiments of the disclosure, an information processing method is provided. The determining first task information associated with the target person includes determining a target evaluation period, and determining the first task information associated with the target person within the target evaluation period.

According to one or more embodiments of the disclosure, an information processing method is provided. the determining, based on the first task information, a recommended evaluator having an association relationship with the first task information includes:
determining a recommended evaluator who has an association relationship with the first task information and does not belong to a preset type of personnel.

According to one or more embodiments of the disclosure, an information processing method is provided. The preset type of personnel includes at least one of the following:
an evaluator in other evaluation sections for the target person, an evaluator invited by default, a person without a first authorization, and a person already resigned.

According to one or more embodiments of the disclosure, an information processing method is provided. The recommended evaluator is bound to the first task information in advance, and the recommended evaluator bound to the first task information remains unchanged after being bound.

According to one or more embodiments of the disclosure, an information processing method is provided. The determining first task information associated with the target person includes:
determining whether there is a selected data source;
if there is the selected data source, determining the first task information based on the selected data source;
if there is no the selected data source, sending a first prompt message.

According to one or more embodiments of the disclosure, an information processing method is provided. Before the determining first task information associated with the target person, the method further includes:
determining whether the target person has a second authorization on task information;
if the target person has the second authorization, determining the first task information associated with the target person; or
if the target person does not have the second authorization, sending a second prompt message.

According to one or more embodiments of the disclosure, an information processing method is provided. Before the displaying the recommended evaluator in a recommendation region of a display interface, the method further includes:
determining whether a preset condition is met, and if the preset condition is met, displaying the recommended evaluator in the recommendation region of the display interface; wherein the preset condition includes at least one of the following: the target person inviting an evaluator for himself/herself, an associated user of the target person having invited an evaluator for the target person, and an option of recommending evaluators being enabled.

According to one or more embodiments of the disclosure, an information processing method is provided. A first identifier is displayed in an associated region of the recommendation region, the first identifier is configured to be triggered to display a third prompt message, and the third prompt message is used to prompt a source of the recommended evaluator.

According to one or more embodiments of the disclosure, an information processing method is provided. The recommended evaluator displayed in the recommendation region has an associated second identifier, and the second identifier is configured to be triggered to add the associated recommended evaluator as an evaluator of the target person.

According to one or more embodiments of the disclosure, an information processing method is provided. After the recommended evaluator is added as an evaluator, the recommended evaluator is hidden in the recommendation region, and no new recommended evaluator is added.

According to one or more embodiments of the disclosure, an information processing method is provided. The method further includes:
in response to a first person being removed from the evaluator of the target person, displaying, if the first person is the recommended evaluator, the first person in the recommendation region.

According to one or more embodiments of the disclosure, an information processing method is provided. Task information includes first-type information and second-type information which are associated; the first-type information or the second-type information in the first task information has an association relationship with the first-type information or the second-type information in second task information of the recommended evaluator; or
the first task information has an association identifier, and the first task information is associated with the recommended evaluator through the association identifier.

According to one or more embodiments of the disclosure, an information processing apparatus is provided. The apparatus includes:
a first determining unit, configured to determine a target person and first task information associated with the target person;
a second determining unit, configured to determine, based on the first task information, a recommended evaluator having an association relationship with the first task information;
a display unit, configured to display the recommended evaluator in a recommendation region of a display interface.

According to one or more embodiments of the disclosure, a terminal is provided. The terminal includes at least one memory and at least one processor.

The at least one memory is configured to store program codes, and the at least one processor is configured to call the program codes stored in the at least one memory to execute above methods.

According to one or more embodiments of the disclosure, a computer-readable storage medium is provided. The computer-readable storage medium stores program codes thereon, the program codes, when executed by a processor, causes the processor to execute the above methods.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. An information processing method, comprising:
determining a target person and first task information associated with the target person;
determining, based on the first task information, a recommended evaluator having an association relationship with the first task information; and
displaying the recommended evaluator in a recommendation region of a display interface.

2. The method according to claim 1, wherein determining the first task information associated with the target person comprises:
determining a target evaluation period, and determining the first task information associated with the target person within the target evaluation period.

3. The method according to claim 1, wherein determining, based on the first task information, the recommended evaluator having the association relationship with the first task information comprises:
determining a recommended evaluator who has an association relationship with the first task information and does not belong to a preset type of personnel.

4. The method according to claim 3, wherein the preset type of personnel comprises at least one of the following:
an evaluator in other evaluation sections for the target person, an evaluator invited by default, a person without a first authorization, and a person already resigned.

5. The method according to claim 1, wherein the recommended evaluator is bound to the first task information in advance, and the recommended evaluator bound to the first task information remains unchanged after being bound.

6. The method according to claim 1, wherein determining the first task information associated with the target person comprises:
determining whether there is a selected data source;
if there is the selected data source, determining the first task information based on the selected data source;
if there is no the selected data source, sending a first prompt message.

7. The method according to claim 1, wherein before determining the first task information associated with the target person, the method further comprises:
determining whether the target person has a second authorization on task information;
if the target person has the second authorization, determining the first task information associated with the target person; or
if the target person does not have the second authorization, sending a second prompt message.

8. The method according to claim 1, wherein before displaying the recommended evaluator in the recommendation region of the display interface, the method further comprises:
determining whether a preset condition is met, and if the preset condition is met, displaying the recommended evaluator in the recommendation region of the display interface; wherein the preset condition comprises at least one of the following: the target person inviting an evaluator for himself/herself, an associated user of the target person having invited an evaluator for the target person, and an option of recommending evaluators being enabled.

9. The method according to claim 1, wherein a first identifier is displayed in an associated region of the recommendation region, the first identifier is configured to be triggered to display a third prompt message, and the third prompt message is used to prompt a source of the recommended evaluator.

10. The method according to claim 1, wherein the recommended evaluator displayed in the recommendation region has an associated second identifier, and the second identifier is configured to be triggered to add the associated recommended evaluator as an evaluator of the target person.

11. The method according to claim 10, wherein after the recommended evaluator is added as an evaluator, the recommended evaluator is hidden in the recommendation region, and no new recommended evaluator is added.

12. The method according to claim 1, further comprising:
in response to a first person being removed from the evaluator of the target person, displaying, if the first person is the recommended evaluator, the first person in the recommendation region.

13. The method according to claim 1, wherein task information comprises first-type information and second-type information which are associated;
the first-type information or the second-type information in the first task information has an association relationship with the first-type information or the second-type information in second task information of the recommended evaluator; or
the first task information has an association identifier, and the first task information is associated with the recommended evaluator through the association identifier.

14. An information processing apparatus, comprising:
a first determining unit, configured to determine a target person and first task information associated with the target person;
a second determining unit, configured to determine, based on the first task information, a recommended evaluator having an association relationship with the first task information;
a display unit, configured to display the recommended evaluator in a recommendation region of a display interface.

15. A terminal, comprising:
at least one memory and at least one processor;
wherein the at least one memory is configured to store program codes, and the at least one processor is configured to call the program codes stored in the at least one memory to execute the method according to claim 1.

16. A computer-readable storage medium, storing program codes thereon, wherein the program codes, when executed by a processor, causes the processor to execute the method according to claim 1.
